(19) United States
(12) Patent Application Publication
(10) Pub. No.: US 2015/0372527 A1
(43) Pub. Date: Dec. 24, 2015

(54) BATTERY THERMAL ACCELERATION MECHANISM

(71) Applicant: Infineon Technologies AG, Neubiberg (DE)

(72) Inventor: Cheow Guan Lim, Singapore (SG)

(21) Appl. No.: 14/312,337

(22) Filed: Jun. 23, 2014

(51) Int. Cl. H02J 7/00

(52) U.S. Cl. CPC H02J 7/0091

(57) ABSTRACT

Devices, systems, and methods for battery supporting, monitoring, and charging are described. In one example, a device includes a temperature measurement device, a controller, coupled to the temperature measuring device, the controller configured to determine an acceleration change in temperature, and a switch, coupled to the controller, configured to disconnect a current associated with the battery when a change in acceleration of temperature is measured.

### TECHNICAL FIELD

This disclosure relates to batteries and more particular, to techniques and circuits associated with battery charging.

### BACKGROUND

Batteries are used in many different electrical or electronic devices. In some examples, the batteries may be rechargeable. Accordingly, systems for charging such batteries and, in some cases, charging such batteries more quickly may be useful. For example, mobile phone, tablets, and other electrical or electronic devices are generally getting more complex. Accordingly, in many cases these devices are using more power and running more power demanding applications. In some cases, in order to supply more power, batteries within such devices are generally getting bigger. As battery size increases, charging may take longer. Accordingly, it can be important to increase charging speed so that devices may be charged quickly.

Charging batteries may lead to battery heating. For example, at elevated temperatures, cathode materials may potentially release oxygen, which can combust the electrolyte and lead to runaway reactions. The cathodes may include layered LiCoO₂, LiNiO₂, and LiMn₂O₄ which may decompose with oxygen when heated in the highly oxidized charged state. Generally, discharge from the cathode is relatively stable with respect to oxygen release. Accordingly, discharge from the cathode may generally be of less concern.

### SUMMARY

In general, techniques and circuits are described that may use changes in acceleration of changes in temperature of a battery to stop current flow associated with a battery, e.g., charging current to the battery, current supplied from the battery, or both to prevent further thermal heat-up to protect the system and user from thermal runaway.

In some examples, the disclosure is directed to a processor-based method that may read temperature data from a temperature sensor on a battery. Instructions for implementing the method may be stored on, for example, firmware or memory, or the methods may be implemented using digital logic, or some combination of one or more processors and digital logic that may be used to process temperature date, such as temperature, change in temperature, acceleration in change in temperature, or other temperature-dependent factors to consider the characteristic of thermal runaways and to, in some examples, provide an early detection of the acceleration of temperature during charging and thus stop charging the battery to allow the battery to cool down.

In an example, the disclosure is directed to a battery supporting device including a temperature measurement device, a controller, coupled to the temperature measuring device, the controller configured to determine an acceleration change in temperature, and a switch, coupled to the controller, configured to disconnect a current associated with the battery when a change in acceleration of temperature is measured.

In another example, the disclosure is directed to a battery supporting system including a battery supporting device including a temperature measurement device, a controller, coupled to the temperature measuring device, the controller configured to determine an acceleration change in temperature, and a switch, coupled to the controller, configured to disconnect a current associated with the battery when a change in acceleration of temperature is measured, and a battery, coupled to the battery charger and configured to be charged by the battery charger.

In another example, the disclosure is directed to a method of charging a battery including measuring a temperature, determining an acceleration in change in temperature, and discontinuing a charging current when a change in acceleration of temperature is measured.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a graph illustrating an example temperature difference between a temperature sensor external to a cell and a temperature sensor internal to a cell for a cell that may be charged in accordance with one or more aspects of the present disclosure.

FIG. 2 is a series of graphs illustrating an example thermal runaway scenario for charging of a cell.

FIG. 3 is a block diagram illustrating an example battery system in accordance with one or more aspects of the present disclosure.

FIG. 4 is a block diagram illustrating an example charging circuit in accordance with one or more aspects of the present disclosure.

FIG. 5 is a graph illustrating an example of temperature and charging current over time in accordance with one or more aspects of the present disclosure.

FIG. 6 is another graph illustrating another example of temperature and charging current over time in accordance with one or more aspects of the present disclosure.

FIG. 7 is another graph illustrating another example of temperature and charging current over time in accordance with one or more aspects of the present disclosure.

FIGS. 8A and 8B are graphs illustrating examples of average current and temperature respectively over time, in accordance with one or more aspects of the present disclosure.

FIG. 9 is a flowchart illustrating an example method for charging a battery, in accordance with one or more aspects of the present disclosure.

### DETAILED DESCRIPTION

Some monitoring and prevention mechanisms with respect to battery faults include overvoltage protection, under-voltage protection, overcharging protection, and over-current protection. These or other monitoring and prevention mechanisms may be used in battery powered electronic devices to protection a battery from these faults. For example, protection shut-down and battery percentage charged measurement may be used for protection of under-voltage and overcharging. State-of-charge and absolute temperature of a battery may also be used to determine the charging current for the battery. For example, state-of-charge may be determined by measuring the voltage at the battery, e.g., when the current is less than a fraction of the rated current for the battery and calculating the charging current used over time. Some current systems charge batteries at a much lower charging current than might be used as the main mechanism to avoid thermal runaway.

With larger battery cells, charging current may become larger, and different amounts of current may be needed to charge a battery for different battery voltages. Additionally, measurement of battery temperature may be used to ensure low battery capacity degradation of the battery over repeated cycles of charging. For example, charging current may be limited based on battery temperature. Using temperature in such a mechanism to ensure the non-degradation of battery capacity, however, does not always help in thermal protection of the battery, especially in the situation of thermal runaway.

Thermal runaway may occur during charging of the battery. For example, some of the energy from current flowing into a battery being charged may be dissipated as heat. Hence, charging the battery may be exothermic, meaning it generates heat. In some examples, charging the battery may be exothermic or endothermic, at a lower state-of-charge but exothermic near full charge in normal operation. This may vary depending on the type of battery. If the amount of heat being dissipated by the battery continues to increase, a thermal runaway may occur.

Thermal runaway may also occur during battery discharging. Some of the energy from the current flowing out of the battery may be dissipated as heat. Generating electric current from the battery may also be an exothermic process. Again, if the amount of heat being dissipated by the battery continues to increase, a thermal runaway may occur. Additionally, temperature of the battery may increase due to power dissipation from circuitry related to battery operation, such as protection circuitry and charging circuitry. Chemical process in the battery, e.g., when it is being charged or discharging current, may also increase the temperature of the battery. These potential temperature increases may also contribute to thermal runaway. Such thermal failures, i.e., thermal runaways, are generally exothermic reactions during which temperature may increase until battery failure.

In some examples, a proposed method may use acceleration and deceleration of temperature changes to help in thermal protection for the battery during battery charging, battery discharging, or both. For example, an accelerating temperature increase in a battery during charging may indicate a thermal runaway. Acceleration and deceleration of temperature changes may also provide indication of overcharging in an otherwise normal battery charging operation. Accordingly, monitoring or detection of temperature acceleration and/or deceleration may serve as an improved protection for battery degradation. For example, overcharging may be indicated by an accelerating temperature increase. While acceleration may be positive or negative, as used herein “acceleration” will generally be used to indicate increases and “deceleration” will be used to indicate decreases, although acceleration may also be used, more generally, to indicate any change (positive or negative).

Battery temperature may be monitored, and battery charging, battery discharging, or both may be stopped based on one or more measurements going above a maximum temperature, measurements indicating a maximum rate of change (e.g., increase) in temperature, measurements indicating an acceleration (generally a positive acceleration) in change of temperature, or other integration or derivative of these. Conversely, battery temperature may be monitored, and charging, e.g., that has been previously stopped may be started again based on one or more measurements going below a predetermined temperature, measurements indicating a lower than maximum rate of change (e.g., increase) in temperature, measurements indicating a predetermined rate of change of a decrease in temperature, a predetermined value measurements indicating a deceleration in change of temperature or an increasing deceleration in change of temperature, or other integration or derivative of these. Furthermore, in some examples, one or more of battery temperature, measurements indicating a maximum rate of change (e.g., increase and/or decrease) in temperature, measurements indicating an acceleration and/or deceleration in change of temperature, or other integration or derivative of these may be used in combination to determine if battery charging/discharging current should be connected or disconnected from one or more batteries, e.g., using one or more of these to further improve the detection. For example, acceleration in temperature increase may be a larger problem as actual temperature increases, e.g., a battery may go from normal charging or discharging to thermal overload when the battery is at a higher temperature to begin with. Accordingly, in some examples, the amount of acceleration in temperature change that may cause charging or discharging to be stopped may be a function of temperature. Furthermore, the temperature for discontinuing charging may be different from the temperature for discontinuing discharging. The temperature for discontinuing charging and the temperature for discontinuing discharging may also vary for different types of batteries.

In some examples, a value or values for positive or negative temperature acceleration, positive or negative increases in temperature acceleration, or other positive or negative integration or positive or negative derivative of these that may cause or allow battery charging or discharging to begin, allow charging or discharging to continue, cause charging or discharging to be discontinue, or cause charging or discharging to remain discontinued or off may be a function of battery temperature and the temperatures may vary between charging and discharging. Furthermore, some examples may combine one or more of these measurements.

In some examples, temperature of the battery may be used mainly to stop the battery from charging or discharging when an absolute is reached, e.g., some absolute temperature. In practices, thermal fuses may be used to discontinue battery charging or discharging. For example, a thermal fuse may be used as thermal isolation during a thermal heat-up. This is possible in a prismatic cell or a cylindered cell and may be built-in. In a cylindered cell, a gas vault that opens or a thermal gas formation may be also used. For polymer cell, which have a flat wide surface compare to its thin thickness, such inbuilt fuse is not presence. In some examples, external temperature sensor may be placed at the center of such a battery to sense its absolute temperature. When a battery is at or near its maximum charge, however, the true internal battery temperature may already be at a high temperature.

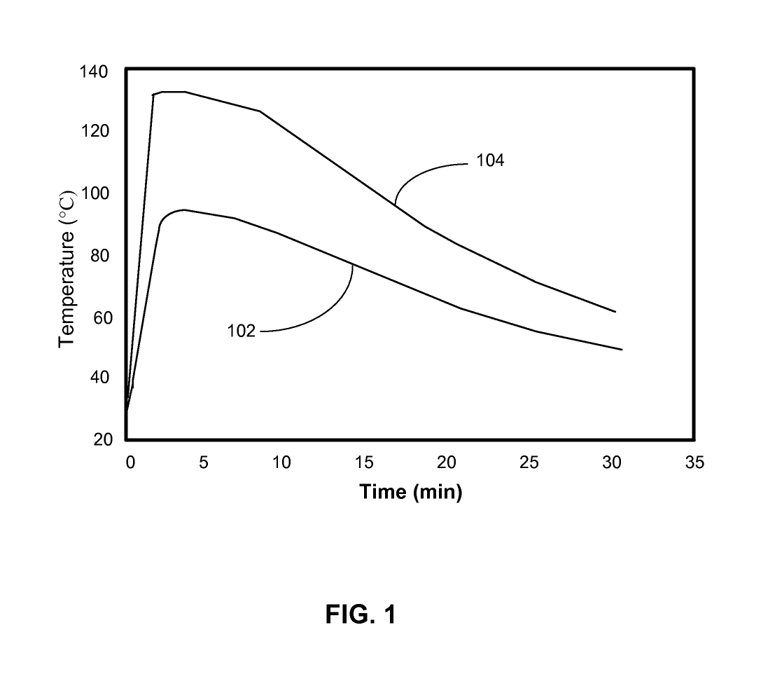

FIG. 1 is a graph illustrating an example temperature difference between an external temperature sensor and a measured internal temperature of a cell. The graph illustrates temperature in ° C. versus time in minutes. More specifically, FIG. 1 illustrates an example temperature overlay plot for a 1.5 Ah prismatic Li-ion cell charged to +4. 1V during a short circuit test. Plot 102 is the temperature measured on the external case of the cell and plot 104 is the temperature measured internally in the electrode stack. As illustrated in FIG. 1, the temperature measured internally in the electrode stack is higher than the temperature measured on the external case of the cell.

In some examples, voltage sensing exceeding the nominal maximum voltage of the battery may be used normally. For example, when battery voltage exceeds the normal maximum voltage a battery charger may stop charging the battery. In some examples an absolute maximum voltage may be used. In other examples, the nominal maximum voltage may be a function of temperature, charge cycles, discharge cycles, or some combination of these. Other ranges for battery voltage may be used, e.g., such as some percentage of the nominal maximum voltage for the battery (which may be a function of temperature, charge cycles, discharge cycles, or some combination of these.) It will further be understood that the temperature or temperatures used to determine when to stop charging the battery or allowing the battery to discharge may be a function of not just the charge/discharge cycles, but how high the battery was charged on previous charge cycles and how deeply the battery was discharged on previous discharge cycles. When a battery overheats it expands. Accordingly, in another example a sensing method may use a stress gauge to determine when expansion is occurring and thereby determining that overheating is occurring. Expansion or acceleration of expansion may be monitored.

In some examples, the systems and methods described herein may be implemented using a controller, such as at least one of a processor, a microprocessor, digital logic, programmable logic, or analog circuitry.

Some examples may read temperature data from a temperature sensor on a battery. The temperature data may include one or more of temperature, change in temperature, or acceleration in change of temperature.

In an example with a controller implementing various aspects of this disclosure, firmware may be used to store instructions for the controller, e.g., processor, microprocessor, or other logic implementing a processor or controller. Digital logic may also be used in some examples.

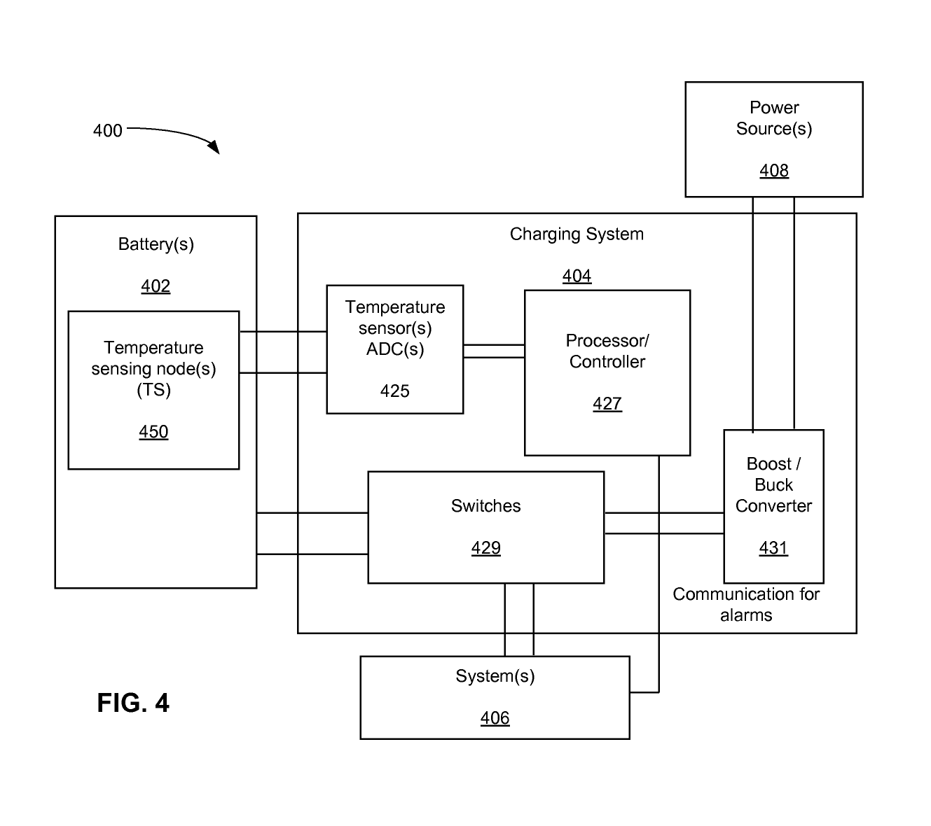

As described herein, a controller, e.g., a processor may measure the characteristics of thermal runaways and provides an early detection of the acceleration of temperature during charging based on the measured characteristics. Accordingly, when such a detection occurs during charging the controller may stop charging of the battery to allow the battery to cool down. Similarly, the controller may measure the characteristics of thermal runaways and provides an early detection of the acceleration of temperature during discharging based on the measured characteristics. Accordingly, when such a detection occurs during discharging the controller may discontinue the discharging from the battery to allow the battery to cool down. (Charging, discharging, or both may be discontinued using switch 429 of FIG. 4, discussed below.)

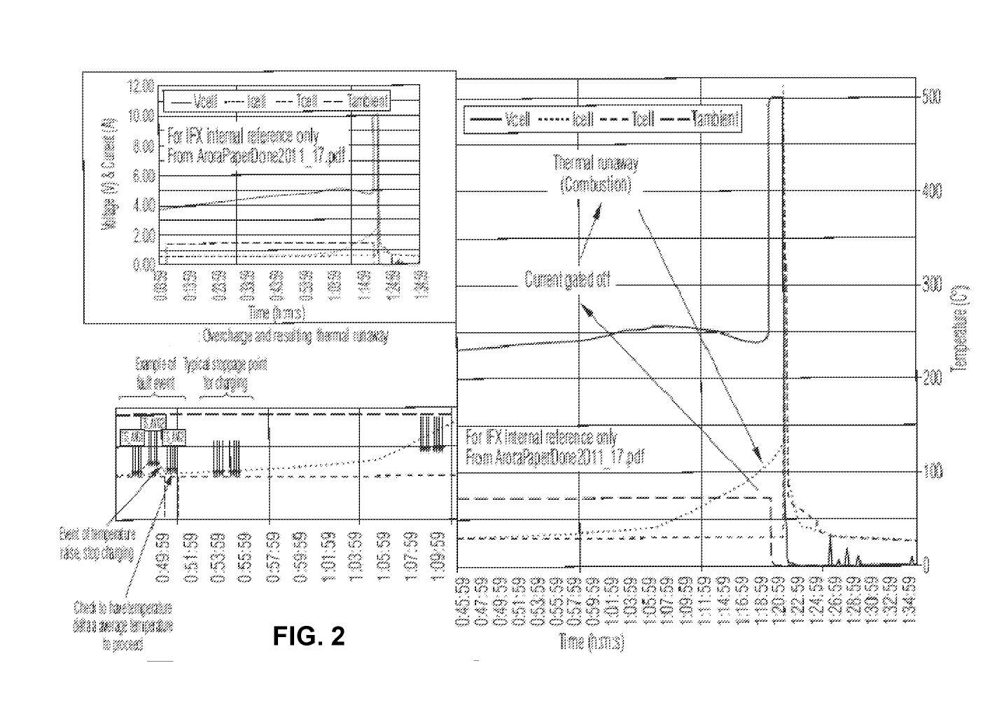

FIG. 2 is a series of graphs illustrating an example thermal runaway scenario for charging of a cell. FIG. 2 also illustrates detection of acceleration of temperature. In some examples, the temperature raise of a battery during charging would remain relatively constant, and via sensing at the center of the battery, the same temperature variation would allow the battery to be charged. Temperature may be sensed a number of times. For example, reading the temperature sensor may be performed every minute, or some other convenient time interval, to sense for temperature changes. In some examples, if the temperature continues to rise over a limit, the charger stops charging the battery while maintaining power to the system.

In addition, in some examples, the charger may keep monitoring the battery, e.g., even when the battery is not being charged. If the battery's temperature continues to raise, the system's power may also be powered off to further reduce the heat up. In some examples, an alarm can also be trigger to warn the user to ensure the device is not close to the body or a flammable object.

Generally, during discharging of a battery, the temperature of the battery will be approximately proportional to the amount of current drawn. In some examples, if temperature of the battery exceeds a predetermined boundary and continues to rise, rises at an accelerating rate, or the acceleration of a rise in temperature increases, a system implementing the methods of this disclosure may disconnect current from the battery or into the battery. For example, the system may power off a charging current to reduce this increasing temperature, acceleration, and/or accelerating increase in acceleration of temperature. In some example, an alarm can also be trigger to reduce the amount of application running to reduce power usage. In other example, an alarm can also be trigger to warn the user to ensure the device is not close to the body or a flammable object or substance.

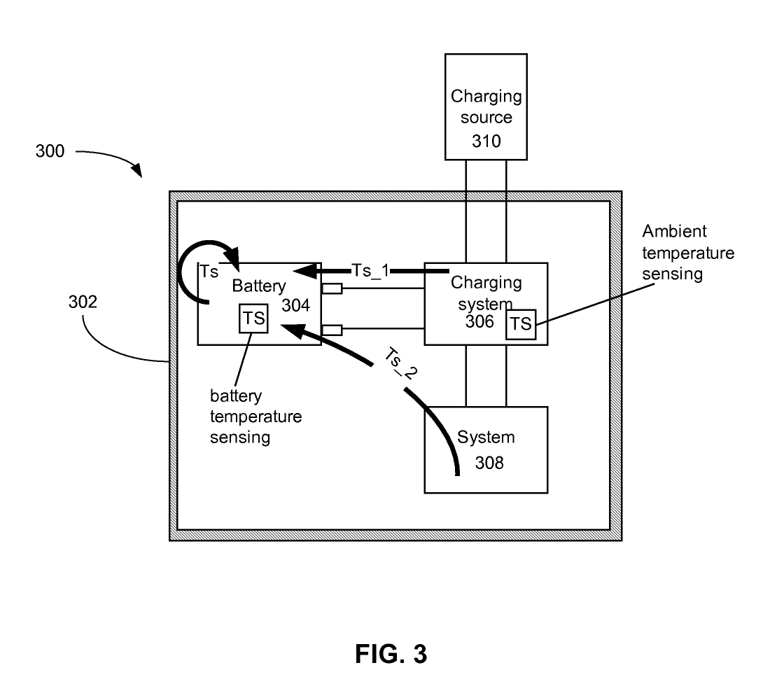

FIG. 3 is a block diagram illustrating an example battery system 300 in accordance with one or more aspects of the present disclosure. Example battery system 300 includes enclosure 302, battery 304, charging system 306, and system 308. A charging source 310 may be coupled to battery system 300 to provide power to battery system 300, e.g., to charge battery 304 or provide power to charge battery 304 or to various circuitry, such as charging system 306, system 308, or one or more temperature sensors (TS) such as battery temperature sensor or ambient temperature sensing (near charging system). Arrows Ts, Ts_1, and Ts_2 indicate some example sources of heat at battery 304. For example, Ts indicates heat from, for example, chemical reactions occurring in battery 304 itself, such as when charging battery 304 or discharging battery 304. Thus heat (Ts) may increase the temperature of battery 304. Ts_1 indicates heat from charging system 306 that may increase the temperature of battery 304. Ts_2 indicates heat from system 308 that may increase the temperature of battery 304.

Charging source 310 may provide current to charging system 306. This current may power system 308, be provided to battery 304, or both. Furthermore, battery 304 may provide current back to charging system 306 and to system 308, e.g., through charging system, 306.

FIG. 4 is a block diagram illustrating an example charging circuit 400 in accordance with one or more aspects of the present disclosure. FIG. 4 is similar to FIG. 3, but includes additional detail. Major components of the illustrated example of FIG. 4 include one or more batteries 402, a charging system 404, one or more systems 406 that may be powered by battery(s) 402, and a power source 408 that may provide power to the charging system 404 and system 406 and battery 402, e.g., through charging system 404.

In the illustrated example, battery 402 includes one or more temperature sensing nodes 450 (TS) which may be temperature measurement device(s). Temperature sensing nodes 450 may be used to measure a temperature of battery 402. Temperature sensor 450 may be mounted on battery 402, in a battery container or case containing battery cells of battery 402, or generally anywhere where the temperature of the battery 402 has a measurable (by the particular temperature sensor used) impact on the temperature measured at the sensor.

Temperature sensor 450 may be coupled to a temperature sensor analog to digital converter (ADC) 425. Temperature sensor(s) ADC may convert analog temperature readings from an analog output of temperature sensing node(s) 450 to a digital form that may be output to processor/controller 427 in a digital form. In other examples, ADC 425 may be part of temperature sending node(s) 450 or processor/controller 427. In some examples, processor/controller 427 includes at least one of a processor, a microprocessor, digital logic, programmable logic, or analog circuitry.

Processor/controller 427 may discontinue a charging current when a change in acceleration of temperature is measured. For example, processor/controller 427 may control a switch or switches 429 that disconnect a charging current from a battery or batteries 402 being charged. In some examples, the switch or switches 429 may include one or more mechanical switches, such as one or more relays, one or more semiconductor devices such as one or more diodes, one or more transistors. The one or more transistors may include, for example, various types of transistors, such as Bipolar junction transistors (BJTs), junction gate field-effect transistors (JFETs), metal-oxide-semiconductor field-effect transistors (MOSFETs), or other types of transistors. In some examples, the semiconductor devices may be formed from, for example, silicon, germanium, gallium arsenide, or other materials that may be doped with impurities that alter its electronic properties in a controllable way. In some examples, processor/controller 427 includes at least one of a processor, a microprocessor, digital logic, programmable logic, or analog circuitry.

In some examples, temperature sensor 450, processor/controller 427, or a combination of both may determine an acceleration in a change in temperature. In some examples, the change in acceleration of temperature comprises an increase in acceleration of temperature.

In an example, temperature sensor 450 may measure temperature and controller/processor 427 may receive a series of measured temperatures from the temperature measuring device. Processor/controller 427 may determine the acceleration change in temperature by comparing the series of measured temperatures.

In another example, temperature sensor 450 may measure change in temperature. Processor/controller 427 may receive a series of measured changes in temperatures from temperature sensor 450. Processor/controller 427 may then determine the acceleration change in temperature by comparing the series of measured changes in temperature.

In yet another example, temperature sensor 450 measures acceleration change in temperature and the controller receives acceleration change in temperature from temperature sensor 450.

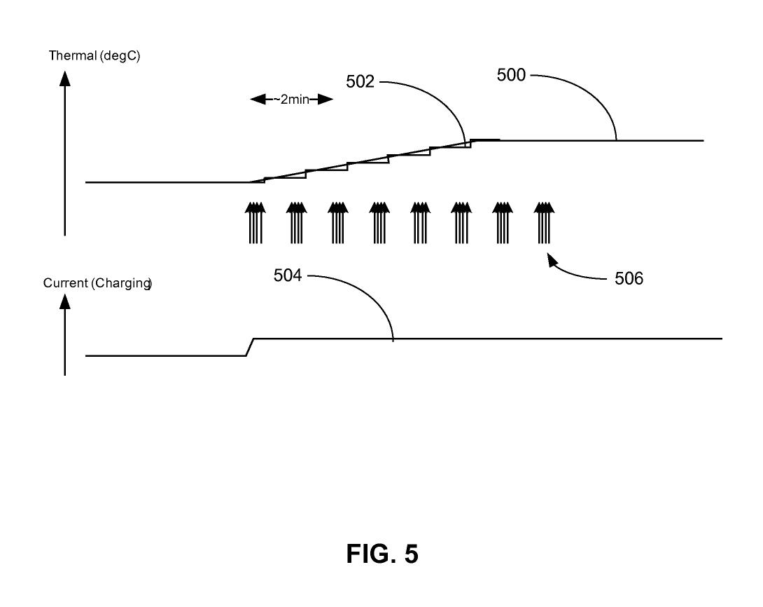

FIG. 5 is a graph illustrating an example of temperature and charging current over time in accordance with one or more aspects of the present disclosure. FIG. 5 illustrates an example of temperature 500, temperature measurements 502, and charging current 504 over time. Temperature may be read from a temperature sensor coupled to a battery (not shown). In the illustrated example, temperature is sampled 8 times every two minutes 506. As illustrated in the particular example of FIG. 5, the samples may be taken in rapid succession four times at the beginning of a two minute period and four times in the middle of the two minute period. The cycle may repeat, as illustrated. As illustrated, current may be used to charge the battery. When the charging current is on the temperature of the battery may rise, as illustrated in FIG. 5. No thermal runaway occurs in the example of FIG. 5, rather, the temperature rises and stabilises at a higher temperature (at least during the period illustrated in the example). While FIG. 5 illustrates an example of temperature and charging current over time in accordance with one or more aspects of the present disclosure, it will be understood that the concepts of this disclosure may be applied to current being supplied by the battery. For example, a battery may supply current. When the current is flowing from the battery, the temperature of the battery may rise, similarly to the graph of FIG. 5, which relates to charging.

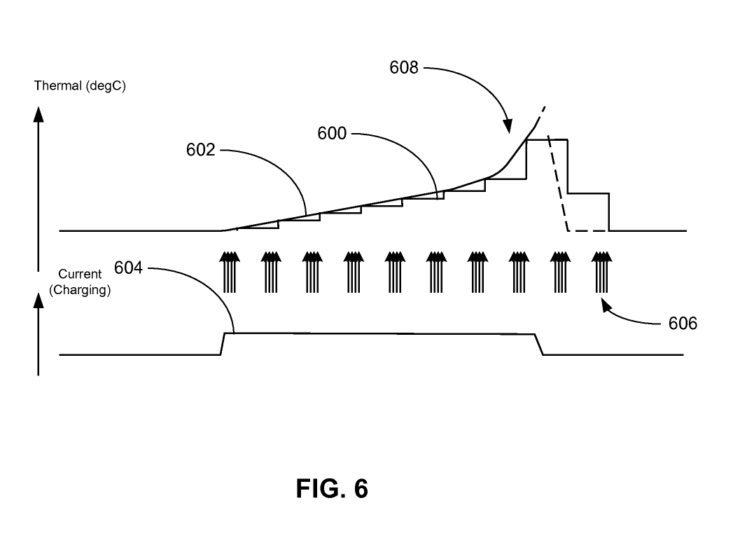

FIG. 6 is another graph illustrating another example of temperature and charging current over time in accordance with one or more aspects of the present disclosure. FIG. 6 illustrates another example of temperature 600, temperature measurements 602, and charging current 604 over time. Temperature may be read from a temperature sensor coupled to a battery (not shown). In the illustrated example, temperature is sampled 8 times every two minutes 606. As illustrated in the particular example of FIG. 6, the samples may be taken in rapid succession four times at the beginning of a two minute period and four times in the middle of the two minute period. They cycle may repeat, as illustrated. As illustrated, current may be used to charge the battery. When the charging current is on the temperature of the battery may rise, as illustrated in FIG. 6. Temperature sensor reading with an acceleration temperature rise 608 and dotted line showing temperature deceleration 610 to normal temperature when charging current is stopped, as illustrated for charging current 604. As illustrated in FIG. 6, charging current 604 goes into the battery and the current may be stopped when the battery temperature with accelerating temperature rise 608 is detected. In some methods, in accordance with one or more aspects of the present disclosure an acceleration change of the temperature of the battery may be used to stop charging. This may prevent further thermal heat-up and may protect a system containing the charging battery. In addition, the techniques may also help prevent harm to a user, which may otherwise be caused by thermal runaway of the battery.

In the illustrated example of FIG. 6, the rate of change of the temperature is measured using a temperature sensor at the battery. This measurement may be made, in one example, every 15 seconds. The measurement may be made, in other examples, more than every 15 seconds or less than every 15 seconds. The exact timing of the measurement is generally not critical, however, taking measurements at a time interval less than every 15 seconds may generate a large amount of data, which may not, in some cases, lead to an increase in performance. Conversely, while taking measurements at a time interval greater than every 15 seconds may lead to a decrease in data, longer time intervals may allow for thermal runaway to occur. Accordingly, it may be preferable in some examples to take measurements at least every 60 seconds. Other examples may take measurements less frequently. Although this timing may vary. For example, some battery chemistries may take longer to experience thermal runaway, accordingly, longer time intervals may be possible.

In some examples, every minute a comparison may be made using past data as illustrated in FIG. 6. For example, every minute a series of samples may be taken and each of these samples may be averaged together. Each minute a new average of a set of samples may be compared to one or more averages of previous series of samples.

Additional sampling may be used for digital averaging to reduce thermal spikes. In some examples, an interval not lesser than 1 second are used. However, the timing is generally not critical, intervals of less than 1 second may generate a larger amount of data, which may not, in some cases, lead to an increase in performance. Intervals longer than 1 second may also be used.

Some example temperature measurement devices may output a voltage that is related to the temperature. Accordingly, a range of voltage levels may be equivalent to an allowed temperature range for operation of the battery monitoring or battery charging circuitry without further checks in accordance with methods described herein. Accordingly, in some examples, only when the temperature is above a trigger voltage level is acceleration in temperature rise or increasing acceleration (or other integrations or differentiations of these) considered to determine if current to or from the battery should be discontinued. In some examples, when the voltage level goes back below the trigger voltage level, the temperature check may continue over a period of time from a minute to an hour before the checking of acceleration in temperature rise or increasing acceleration (or other integrations or differentiations of these) are discontinued or disabled. Various aspects may be programmable to allow the flexibility to adjust according to battery usage, type and size.

An example computation to allow further charging is illustrated below. This is only an example, however, and the details in the illustrated example, may be changed to optimize for a particular charging system, or the battery or batteries to be charged.

In some examples, TS1 may be defined as a single sample of an average sum of multiple temperature samples during a first period of time. TS2 may be a single sample of a average sum of multiple temperature sample during a second period of time following the first period of time. TS3 may be a single sample of a average sum of multiple temperature sample during a third next period of time following the second period of time. (Other sets of temperature samples and averages, TS4, TS5, . . . may follow.) TS0 may be defined as the ambient temperature that is measure before any exothermic event. Ambient temperature may normally be measure when the system is in an idle state and where the current consumed or charging the battery may be at a minimal level, which, in some examples, may be at least 10 lower than the rated current of the battery or even lower in some examples.

In some examples, an addition current control loop may be also allowed over the temperature acceleration or deceleration. In some charging systems different computations may be used for different battery types to be charged.

In the example discussed below, A1 is the difference of TS2 to TS1 and A2 is the difference of TS3 to TS2.

If (A1 and A2 are not zeros and both greater than D) // D is delta
temperature jitter to filter)
Begin

Case (A2 − A1):

> T1: disable charging; // T1 is a programmable value, e.g.
0.5degC
>=0: if (either A2 or A1 > T2)

| | |
|---|---|
| disable charging | or reduce charging current by X ratio; |

// derivative increase. T2 is programmable value, e.g. 2degC

<0: continue charging at current level

Default: < continue charging at current level >;
End
Else If (A2 not zeros and greater than D)
Begin

if (either A2 or A1 > T2)

Reduce charging current by X ratio;

// optional charge current control to regulate over temperature.
//X is programmable value

End
Else if (A1 is zero and A2 is zero or less than zeros)
Begin

Recover any charging current reduction made with an increase
by Y ratio;

//Y is programmable value, can be the same ratio as X.

End
A example during discharging,

If (A1 and A2 are not zeros and both greater than D)
// D is delta temperature jitter to filter
Begin

Case (A2 − A1):

> T3: Alarm system and disable discharge current to part/full
system if not
action in B1;
// T3 is a programmable value, e.g. 0.5degC; B1 is the max time
that a system acknowledge to the alarm. If no response is make,
the system is likely in locked in some process that is causing
undesirable high current consumption or have result in undesired
thermal condition.
>=0: if (either A2 or A1 > T4)

Alarm system and option to disable discharge current to
part/full system if not action in B1;
// derivative increase. T4 is programmable value, e.g.
4degC

<0: allow current operation discharging current;
Default: < allow current operation discharging current >;

End

Else If (A2 not zeros and greater than D)

Begin

if (either A2 or A1 > T4)

Alarm system and option to disable discharge current to
part/full system if not action in B1;

//

End

Else if (A1 is zero and A2 is zero or less than zeros)

Begin

allow current operation discharging current //

End

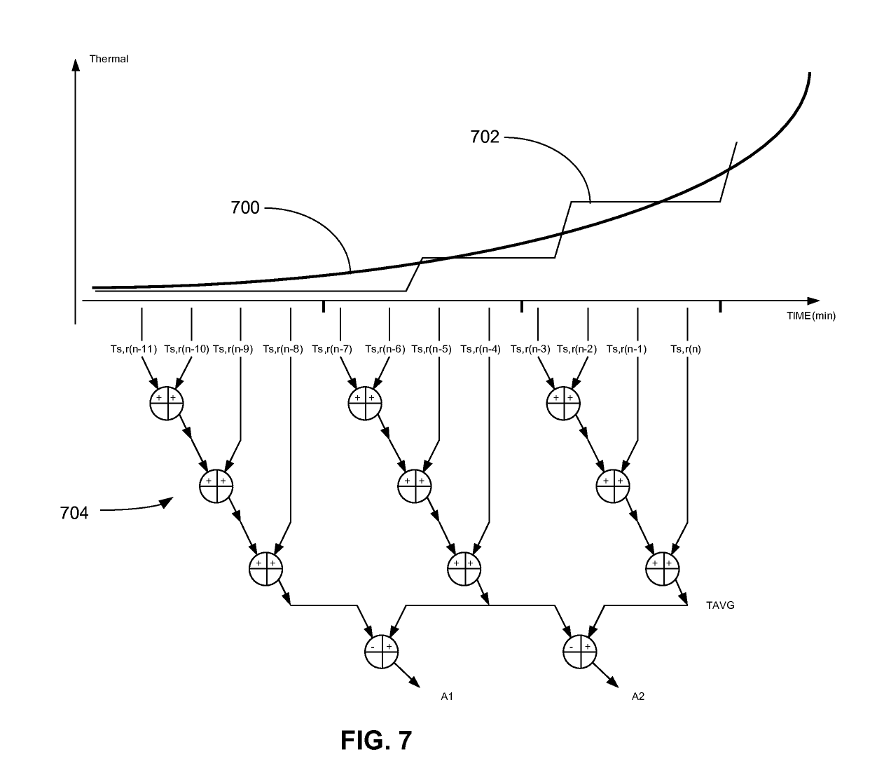

FIG. 7 is graph illustrating another example of temperature and charging current over time in accordance with one or more aspects of the present disclosure. As illustrated in FIG. 7, the top graph includes temperature (a thermal indication) versus time. Examples of temperature at the battery 700 and temperature sensor read-out 702 are both illustrated in FIG. 7. digital logic 704 may be used to average temperature measurements over time. For example, the temperature data may be averaged every minute over time and output the arithmetic result of A1 and A2 to the processor. Other periods may be used for averaging, including everywhere from fractions of seconds to minutes or even longer.

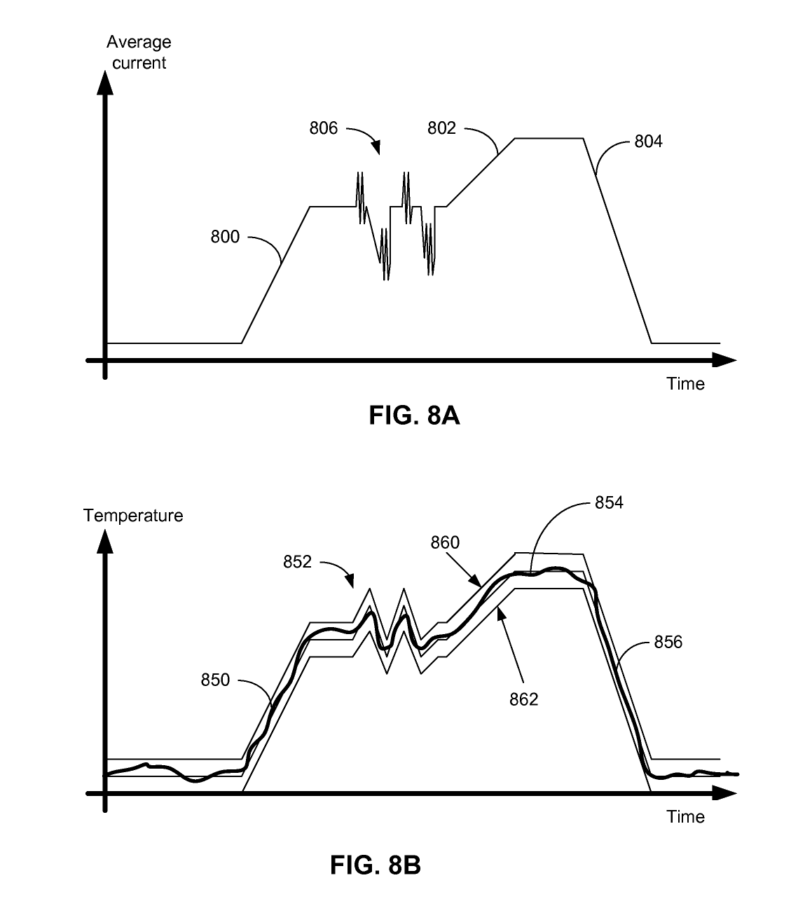

FIG. 8A is a graph illustrating an example of average current over time, in accordance with one or more aspects of the present disclosure. FIG. 8B is a graphs illustrating an example of temperature over time, in accordance with one or more aspects of the present disclosure. The time axis of both FIG. 8A and FIG. 8B span the same period of time. FIG. 8A illustrates current increases 800, 802; a current decrease 804; and a rapid series of current changes 806. The illustrated rapid series of current changes 806 of FIG. 8A include increases in current, decreases in current, and rapid changes between the increases in current and decreases in current.

As illustrated in FIGS. 8A-8B, during charging or discharging, the temperature changes of the battery may remain relative proportional to the amount of charging current or current draw. Thus, as current increases 800, temperature generally increases 850. As the current experiences a rapid series of current changes 806, temperature generally experiences a rapid series of current changes 852. As current increases 802, temperature generally increases 854. As current decreases 804, temperature generally decreases 856.

A high temperature boundary 860 and a low temperature boundary 862 are also illustrated. Temperature may generally stay between high temperature boundary 860 and low temperature boundary 862. In some examples, if the temperature exceeds high temperature boundary 860 and continue to rise, the system's power or current to or from the battery may be discontinued. This may generally reduce the temperature increase. In some example, an alarm can also be trigger to reduce the amount of application running to reduce power usage. In other example, an alarm can also be trigger to warn the user to ensure the device is not close to the body or a flammable object.

In some examples, a control loop may regulate the current higher or lower for charging and checking that the temperature follows a temperature pattern, e.g., similar to the graphs illustrated in FIGS. 8A-8B for discharging. During charging or discharging a table may be used to determine if a temperature level and charging current are within an acceptable range.

Battery temperature may also be a function of ambient temperature. Accordingly, increases in temperature from ambient may be considered for inclusion in a table, such as the table described above. In one particular example, where charging current and temperature are not linearly related, charging at a current X may result in a temperature of Y, or a particular change or increase in temperature relative to ambient temperature. For a charging current of X/2, the temperature (or change in temperature relative to ambient temperature) may reduce to, e.g., Y/3 and if the current is at X/4, the temperature (or change in temperature relative to ambient temperature) may be Y/7. There is a certain permissible pattern with a certain tolerance given. In additional, in different battery states, the patterns may change. Tables in accordance with the systems and methods described herein may be determined for particular battery cells, battery cell types, batteries, combinations of battery cells, temperatures, temperature ranges, and other variables that may impact battery performance. Patterns so determined may be stored as a table or an array of tables according to current, temperature (or change in temperature), state-of-charge, or other variables that may impact battery performance. Lower and higher temperatures or changed in temperature than within boundaries or tolerances determined for the table may mean a battery, battery cell, or array of battery cells are at a different state of charge.

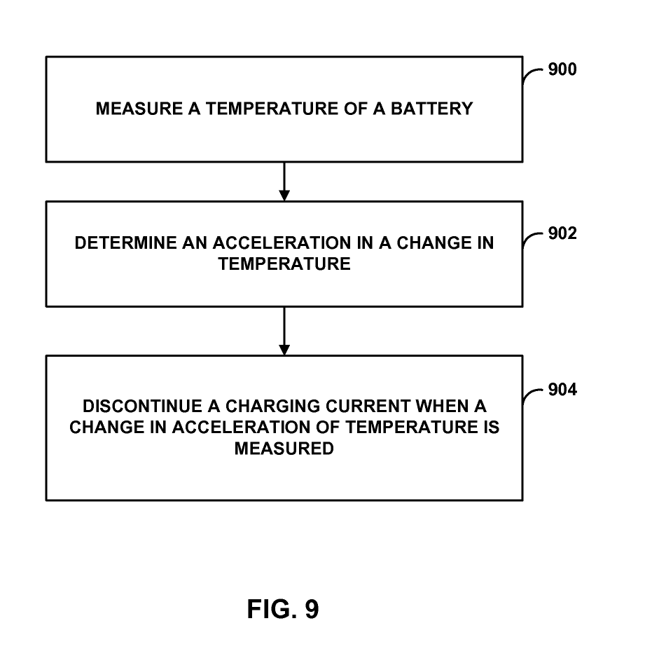

FIG. 9 is a flowchart illustrating an example method for charging a battery 402 (or batteries), in accordance with one or more aspects of the present disclosure. In the example method for charging battery 402 temperature measurement device(s) such as temperature sensor(s) (TS) 450, also referred to as temperature sensing node(s), may be used to measure a temperature of battery 402 (900). Temperature sensor 450 may be coupled to a temperature sensor analog to digital converter 425 so that an analog temperature reading may be output to processor 427 in a digital form. Temperature sensor 450 may be mounted on battery 402, in a battery container or case containing battery cells of battery 402, or generally anywhere where the temperature of the battery 402 has a measurable (by the particular temperature sensor used) impact on the temperature measured at the sensor.

Temperature sensor 450, processor/controller 427, or a combination of both may determine an acceleration in a change in temperature (902). In some examples, the change in acceleration of temperature comprises an increase in acceleration of temperature.

In an example, the temperature sensor 450 may measure temperature and controller/processor 427 may receive a series of measured temperatures from the temperature measuring device. Processor/controller 427 may determine the acceleration change in temperature by comparing the series of measured temperatures.

In another example, temperature sensor 450 may measure change in temperature. Processor/controller 427 may receive a series of measured changes in temperatures from temperature sensor 450. Processor/controller 427 may then determine the acceleration change in temperature by comparing the series of measured changes in temperature.

In yet another example, temperature sensor 450 measures acceleration change in temperature and the controller receives acceleration change in temperature from temperature sensor 450.

Processor/controller 427 may discontinue a charging current when a change in acceleration of temperature is measured (904). For example, processor/controller 427 may control a switch or switches 429 that disconnect a charging current from a battery or batteries 402 being charged. The charging current may be provided by boost/buck converter 431 from power source 408. Additionally, switches 429 may also be used to connect battery power or power from boost/buck converter 431 to system 406. In some examples, the controller may be further configured to disconnect a charging current, e.g., using the switch, when a predetermined maximum temperature is measured.

Some example battery monitoring or battery supporting devices may include a temperature measurement device, a controller, coupled to the temperature measuring device, the controller configured to determine an increase in temperature, an acceleration in change in temperature, or an increasing acceleration in change in temperature and a switch, coupled to the controller, configured to disconnect a current when a predetermined increase in temperature, an acceleration in change in temperature, or an increasing acceleration in change in temperature is measured or some combination of these occurs.

Some example battery monitoring or supporting devices may include means for measuring a temperature, means for determining an increase in temperature, an acceleration in change in temperature, or an increasing acceleration in change in temperature, and means for discontinuing a current when a predetermined increase in temperature, an acceleration in change in temperature, or an increasing acceleration in change in temperature is measured or some combination of these occurs. Some examples may include a non-transitory computer readable storage medium storing instructions that upon execution by one or more processors cause the one or more processors to measure a temperature, determine an increase in temperature, an acceleration in change in temperature, or an increasing acceleration in change in temperature, and discontinue a current when a predetermined increase in temperature, an acceleration in change in temperature, or an increasing acceleration in change in temperature is measured or some combination of these occurs.

In some example implementations, firmware, hardware logic, or both firmware and hardware logic may be used. Various implementations test rate of change of one or more internal temperature sensors, external temperature sensor, or both to determine battery behavior or battery behavior on system level.

In another example a stress gauge wrapped around the battery, e.g., the center of the battery, may be used because a battery experiencing thermal runaway may expand due to the heat. As the battery expands stress on the stress gauge may increase. This stress may be monitored for a maximum stress value, a maximum rate of change (e.g., increase) in stress value, an acceleration in change of stress value, or other integration or derivative of these.

A computer-readable storage medium may form part of a computer program product, which may include packaging materials. A computer-readable storage medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. A computer-readable storage medium may comprise a non-transitory computer data storage medium. The techniques additionally, or alternatively, may be realized at least in part by a computer-readable communication medium that carries or communicates code in the form of instructions or data structures and that can be accessed, read, and/or executed by a computer. The computer readable storage medium may store instructions that upon execution by one or more processors cause the one or more processors to perform one or more aspects of this disclosure.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules. The disclosure also contemplates any of a variety of integrated circuit devices that include circuitry to implement one or more of the techniques described in this disclosure. Such circuitry may be provided in a single integrated circuit chip or in multiple, interoperable integrated circuit chips in a so-called chipset. Such integrated circuit devices may be used in a variety of applications.

Various examples have been described. These and other examples are within the scope of the following claims.

1. A battery supporting device comprising:
a temperature measurement device;
a controller, coupled to the temperature measuring device, the controller configured to determine an increasing acceleration change in temperature; and
a switch, coupled to the controller, configured to disconnect a current associated with a battery when an increasing change in acceleration of temperature is determined to prevent thermal damage to the battery.

2. The battery supporting device of claim 1, wherein the battery supporting device comprises a battery charging device and the current associated with the battery comprises a battery charging current.

3. The battery supporting device of claim 1, wherein the battery supporting device comprises a battery monitoring device and the current associated with the battery comprises a current supplied from the battery to a load.

4. The battery supporting device of claim 1, wherein the battery supporting device comprises both a battery charging device and a monitoring device.

5. The battery supporting device of claim 1, wherein the temperature measuring device measures temperature, the controller receives a series of measured temperatures from the temperature measuring device and determines the acceleration change in temperature by comparing the series of measured temperatures.

6. The battery supporting device of claim 1, wherein the temperature measuring device measures change in temperature, the controller receives a series of measured changes in temperatures from the temperature measuring device and determines the acceleration change in temperature by comparing the series of measured changes in temperature.

7. The battery supporting device of claim 1, wherein the temperature measuring device measures acceleration change in temperature and the controller receives acceleration change in temperature from the temperature measuring device.

8. The battery supporting of claim 1, wherein the switch is further configured to disconnect a charging current when a predetermined maximum temperature is measured.

9. The battery supporting of claim 1, wherein the change in acceleration of temperature comprises an increase in acceleration of temperature.

10. A battery supporting system comprising:
a battery supporting device including:
a temperature measurement device;
a controller, coupled to the temperature measuring device, the controller configured to determine an increasing acceleration change in temperature; and
a switch, coupled to the controller, configured to disconnect a current associated with a battery when an increasing change in acceleration of temperature is determined to prevent thermal damage to the battery; and
the battery, coupled to the battery supporting device and configured to be monitored by the battery supporting device.

11. The battery supporting system of claim 10, wherein the battery supporting device comprises a battery charging device and the current associated with the battery comprises a battery charging current.

12. The battery supporting system of claim 10, wherein the battery supporting device comprises a battery monitoring device and the current associated with the battery comprises a current supplied from the battery to a load.

13. The battery supporting system of claim 10, wherein the battery supporting device comprises both a battery charging device and a monitoring device.

14. The battery supporting system of claim 10, wherein the temperature measuring device measures temperature, the controller receives a series of measured temperatures from the temperature measuring device and determines the acceleration change in temperature by comparing the series of measured temperatures.

15. The battery supporting system of claim 10, wherein the temperature measuring device measures change in temperature, the controller receives a series of measured changes in temperatures from the temperature measuring device and determines the acceleration change in temperature by comparing the series of measured changes in temperature.

16. The battery supporting system of claim 10, wherein the temperature measuring device measures acceleration change in temperature and the controller receives acceleration change in temperature from the temperature measuring device.

17. The battery supporting system of claim 10, wherein the switch is further configured to disconnect a charging current when a predetermined maximum temperature is measured.

18. The battery supporting system of claim 10, wherein the change in acceleration of temperature comprises an increase in acceleration of temperature.

19. A method of supporting a battery comprising:
measuring a temperature;
determining an increasing acceleration in change in temperature; and
discontinuing a current associated with the battery when an increasing change in acceleration of temperature is determined to prevent thermal damage to the battery.

20. The method of charging a battery of claim 19, wherein the current associated with the battery comprises a battery charging current.
